(19) United States
(12) Patent Application Publication
(10) Pub. No.: US 2001/0034740 A1
(43) Pub. Date: Oct. 25, 2001

(54) Weighted interactive grid presentation system and method for streaming a multimedia collage

(76) Inventor: Andruid Kerne, New York, NY (US)

Correspondence Address: PERKINS, SMITH & COHEN LLP, ONE BEACON STREET, 30TH FLOOR, BOSTON, MA, 02108, US

(21) Appl. No.: 09/784,369

(22) Filed: Feb. 14, 2001

Related U.S. Application Data
(60) Provisional application No. 60/182,319, filed on Feb. 14, 2000.

(51) Int. Cl. G09G 5/12

(52) U.S. Cl. 707/500.1

(57) ABSTRACT

A presentation grid for simultaneously visualizing elements from a large number of multimedia documents is disclosed. Each of these media elements is an image, a chunk of text, a digital video or multimedia. Media elements are gradually streamed onto the presentation grid, forming a collage. This streaming of media elements happens over time, presenting more and more elements. Eventually, the grid fills: when new elements are added, they must overlap ones which are already there. Placement of elements in the grid is based on a model of their importance to the user. This agent model is implemented through a directed graph of the elements, and weights which quantify their importance. It evolves through interaction. By dynamically prioritizing the allocation of screen space based on the user's interests, the weighted grid presentation system makes the streaming collage a useful and engaging means of visualizing media elements and the documents they represent.

### CROSS-REFERENCE TO RELATED APPLICATIONS

This application claims priority of U.S. provisional applications Ser. No. 60/182,319 entitled, “Weighted Interactive Grid Presentation System and Method for Streaming Multimedia Collage” filed Feb. 14, 2000 by the present applicant.

### FIELD OF THE INVENTION

This invention relates generally to a method and apparatus for presenting information to users of computer systems, and more particularly, to a new computer interface for displaying, browsing, visualizing, and navigating large sets of multimedia documents.

### BACKGROUND OF THE INVENTION

Computer databases and the Internet comprise enormous sets of multimedia documents and interdocument references. The documents, themselves, like database records, typically constitute collections of media elements, and references to other documents and media elements. (Hyperlinks are a typical form of this kind of reference; hyperlinked multimedia documents are known as hypermedia.) Space on a computer display screen is inadequate for displaying all the elements of these large collections at one time. The process of browsing is equivalent to the pursuit of media elements of interest. Typically, the user must navigate through documents in order to find those pearls of media which satisfy her/his desire.

When one does not know the exact whereabouts of media of interest, this process of finding it can be time-consuming. Even when one has a general idea, clicking through hyperlinks can be a tiresome exercise. One solution to these problems is to simultaneously display multiple sources of data on a user interface. An added benefit of this type of user interface, according to cognitive scientists, is that when a person sees representations of concepts in proximity, it can stimulate the emergence of new ideas.

Prior art streaming collage user interfaces are inadequate because they are too random in their use of the screen real estate. Elements of no particular interest to the user cover elements of interest.

Prior art information visualization tools, such as zoomable interfaces, and a hyperbolic browser have supplied visualizations exclusively by providing a perspective on the structure created by an author.

It remains desirable to have a computer user interface that shows a plurality of media elements in a useful way.

It is an object of the present invention to provide a method and apparatus providing an improved user interface to the Web, the personal computer, the fileserver, and the multimedia database repository.

It is another object of the present invention to provide a method and apparatus to stimulate human creativity.

### SUMMARY OF THE INVENTION

The problems of visualizing digital media from a plurality of collections of digital media on a computer display screen are solved by the present invention of a weighted interactive grid for streaming a multimedia collage.

The collage system discloses a new presentation system which decomposes documents and database records sets into media elements. These elements are presented as a collage which continues to develop over time. The system brings the media elements to the user and allows the user to peruse and interact with them. The system incorporates an agent which models the user's interests through a referential structure (directed graph) of weights. The system automates the retrieval of information by presenting the media elements in a grid, which dynamically allocates screen real estate according to the priorities established by the model. The system also supports a digital form of serendipity.

The system has a weighted grid system. Each media element is a graphical representation of a part of a document or a multimedia record. These media elements come from the World Wide Web, or any other source of documents such as any network or data storage device either distributed or on a single computer. Initial documents, which take the form of HTML pages in the current preferred embodiment, are parsed. Collections of media elements and hyperlinks are generated. The system assigns weights to each of these. Based on these weights, the invention chooses elements for presentation. At a time interval specified by the user, for example, once per second, a new element is added to the collage via the weighted grid structure.

When a new element is added, the grid is translated into a set of candidate regions, each of size equal to that of the new element. Based on the weights of the media elements in the collage, a weight is associated with each grid cell and with each candidate grid region. The weighting of elements, and corresponding weighting of grid regions, allows for the overlapping of previous elements by new ones. The overlapping is to be performed so as to cover a region of minimal importance.

A weight processor assigns initial weights to elements and alters the weights in response to user interaction with the system over the course of system operation. An interactive interface enables the user to interact with the collage system. The user's inputs effect the agent model, thereby altering the weights of elements and the connections between the elements as stored in the document component store. The changes in the values and connections in the documents component store affect what is seen in the collage display by the user. In other words, this component takes input that forms and dynamically alters a model of the user's interests. It enables the system to adapt its presentation based on the user's interactions. In brief, the collage system forms an adaptive human computer interface system. Not only does the grid reflect a notion of “interesting content” a priori, but also, this notion is updated according to the user's directly expressed interests. The resulting interactive system feels responsive to the user and streams interesting content on the user's behalf.

The present invention together with the above and other advantages may best be understood from the following detailed description of the embodiments of the invention illustrated in the drawings, wherein:

### BRIEF DESCRIPTION OF THE DRAWINGS

FIG. 1 is a block diagram of the streaming multimedia collage system according to principles of the invention;

FIG. 2 is flow chart of the process of breaking documents down into document components, and selecting document references for further processing;

FIG. 3 is a flow chart of the overview of the process of establishing a weighted presentation grid of the multimedia collage system of FIG. 1;

FIG. 4 is a flow chart of the process of initializing the weighted presentation grid of FIG. 3;

FIG. 5 is a flow chart of the process of updating the weighted presentation grid of FIG. 3;

FIG. 6 is a flow chart of the process of choosing a presentation size of an element to be added to the weighted presentation grid of FIG. 3;

FIG. 7 is a flow chart of the process of placing a new element into the weighted presentation grid of FIG. 3;

FIG. 8a is a first part of a flow chart of the process of choosing an initial size in grid units of an element to be placed in the weighted presentation grid in FIG. 6; FIG. 8b is a continuation of the flow chart of FIG. 8a ; and

FIG. 9 is a block diagram of data records in the document component store of FIG. 1.

### DETAILED DESCRIPTION OF PREFERRED EMBODIMENTS

The following definitions apply herein:

Screen real estate is the area of the visual display.

A software component, in object oriented software design, is a functional module which, while it may need other components in order to create a complete application, forms a constituent whole within itself. Each software component has well-defined interfaces which specify input and output flow of data objects and the software component's user-perceivable behaviors.

A media element is an element of digital media which can be presented in the grid of the streaming collage of the present invention. A media element may be an image, a chunk of text, a digital video or a multimedia element. In the current preferred embodiment of the invention, only images and text chunks are supported.

A document is a formatted sequence of text, multimedia, and references to other documents; these interdocument references may take the form of hyperlinks. In the current embodiment of the invention, these documents are typically HTML pages. Typically, the sequential aspect of documents is perceived as inherent, whether one reads a book, a newspaper, or a web page. In the present invention, the document parser breaks documents down, maintaining the constituent media elements and hyperlinks as essential structure, and de-emphasizing their original sequence and formatting. That is, a document is treated as a set of media elements, in which hyperlinks may be embedded. It is a container of document components.

The digital media accessor obtains documents from source devices, such as web servers. Source devices may store these documents in a static form, or they may generate them dynamically. Sources which compose documents dynamically may do so in response to queries from a user. Search engines are an example. They may also incorporate real time data, such as stock quotes, in the documents they dynamically compose and provide.

A document component may be a media element, or a hyperlink, which is a reference to another document. In cases where the referenced document is one which the system has already acquired, the hyperlink effectively makes that document, itself, a component of the referring document.

A containing document of a media element is the document from which a media element originated. That is, the containing document is the document whose parsing first resulted in the media element's being added to the global collection of media elements.

A weight is a floating point number associated with a document, hyperlink, or media element. Weights quantify the importance or priority of each document component. The weights and the referential structure which links them model the user's interests. Weights span the full range of positive floating point numbers. There are two kinds of weights. For significance weights, larger numbers signify a greater level of interest. Screen weights are the reciprocal, or multiplicative inverse. Larger screen weights signify a lower level of interest, that is, a greater eligibility for being covered by the placement of a new element into the grid.

The agent model is a data structure through which the present invention learns about the user's interests. The collage system makes a series of choices: it selects document components, and it also decides where to place new media elements in the weighted presentation grid. The agent model enables the invention to make these choices on the user's behalf. The agent model consists of the weights of documents and document components, and the referential structure through which the document and document components are connected. During the course of a session, first through document parsing operations, and then in response to user interaction, the model evolves. As weight alterations are propagated through the model, the invention engages in “machine learning”. Based on this machine learning, through the agent model, the present invention tailors the results of each session to the individual user's interests.

A weighted random select operation is a random selection from a set of choices. A weight (represented as a floating point number) is associated with each choice, indicating its strength in the whole. Random select may be implemented by creating an array of partial sums for the elements of the set, where the partial sum equals the weight of the current element added to the partial sum for the previous element. A random number between zero and one is obtained and multiplied by the last partial sum. This is the random weight. The array of partial sums is searched for the least that is greater than or equal to the random weight. The element from the original set associated with this partial sum is the element selected.

The use of weighted random selection both focuses and broadens the choices made by the system. The use of weights in the selection process manifests the model of user interests that the weights represent. At the same time, the use of randomness ensures that even when the user has expressed extensive interests, a few elements outside of this interest range will be selected. This prevents the total range of visualized media from growing too narrow. It maintains the circulation of new material into the visualization.

The collage system is a system for presenting a large collection of media elements. In the case where the media elements are drawn from documents, the media elements act to represent significant aspects of the documents. By representing the documents by media elements, aspects of many documents can be displayed at one time. By continuously streaming elements into the multimedia collage of the user interface over time, and by overlapping the elements, the invention makes aspects of even more documents available. The method of placing and overlapping media elements described herein brings a significant number of interesting elements to the user's attention. The weighting mechanism focuses the selections towards the user's interests. This is what makes the system responsive, and thus suitable for browsing large sets of multimedia documents. The use of chance in the present invention introduces an element of surprise which may be entertaining. Serendipity, the chance occurrence of significant relationships, is thus cultivated. Unexpected combinations of images and texts may be provocative. For example, a writer may use the invention on a work in progress to suggest new ideas in the case of writer's block. People collaborating on a project may use it to share the flurry of the activity of the whole.

In addition to functioning as a mechanism for users to access information originally designed for presentation via other means, the current invention may also work as a deliberate form for presenters of information. Other types of digital media interfaces that may use the present invention include electronic kiosks or interactive catalogues. Typically, interactive kiosks and catalogs do nothing in the absence of requests from the user. This invention can be used as means to display available wares actively. The collage system of the present invention can proceed with minimal effort from the passive form of the interactive catalog.

### Sources of Media Elements and Weights

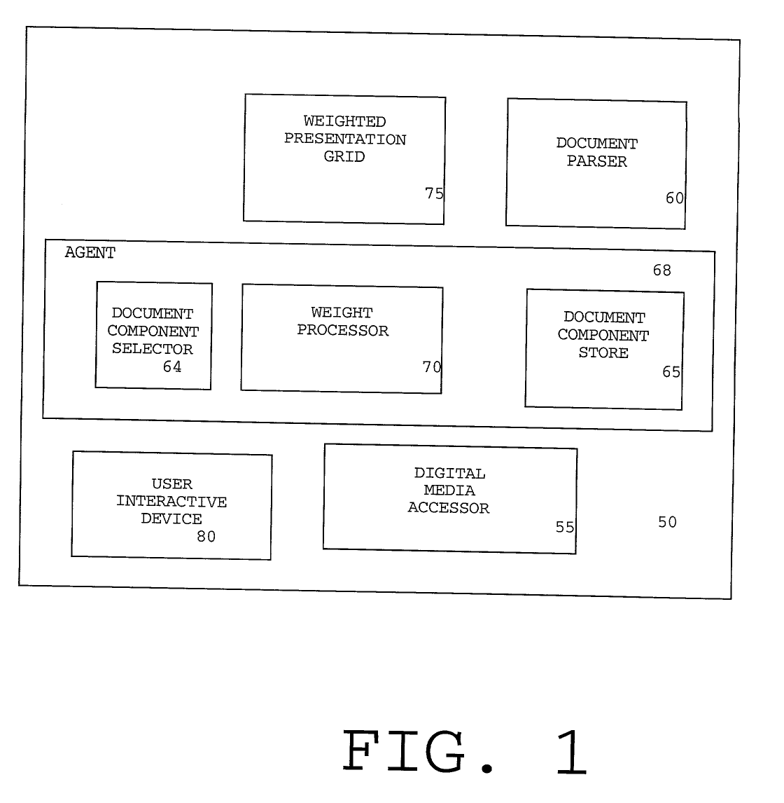

FIG. 1 is a block diagram of the streaming multimedia collage system 50 according to principles of the invention. The system 50 has a digital media accessor 55 that retrieves multimedia documents from at least one source. The source may be a personal computer, a file server, or a database or a network such as the Internet. The documents in the present invention are typically web pages. The digital media accessor 55 retrieves documents from the source and feeds them to the document parser 60. The document parser 60 decomposes the web pages into document components. The system stores the media elements in a document component store 65. Documents and media elements are stored in the document component store as nodes in a directed graph whose connections (edges) represent the underlying hypermedia referential navigation structure. This data structure is built by the document parser 60 iteratively and recursively, over time, as the system downloads documents.

A weight processor 70 assigns weights to the stored media elements and alters them over the course of operation of the system. The weight processor assigns two kinds of weights to the media elements, a significance weight and a screen weight. These weights are floating point numbers, and use the full range of positive values permissible for such numbers on the implementation platform. The more interesting the media element is considered to be, the larger the significance weight. The screen weight works inversely—it grows larger as a media element is of less interest. This inverse relationship is useful for the weighted random select operations. The screen weights are for the grid placement calculations. These calculations determine what to cover up or remove, not what to add.

The document component selector 64, the weight processor 70, and the document component store 65 form an agent. The agent receives the user preferences and records them as weight changes and links between document components on a session by session basis. The weights and links between the document components in the document component store form a model of the user's interests and preferences over the course of the operation of the system. In the current embodiment, this model exists on a session by session basis.

A weighted presentation grid 75 displays media elements taken from the document component store by the document component selector 64 according to the weight of the media element. The weighted presentation grid regularly updates its presentation based on changes in weights. The screen weight affects where a media element is displayed on the grid and also whether or not a media element is retained in the display.

The user manipulates the visual state of the collage with a user interactive device 80 that affords point and click, drag and drop interaction with media elements in the grid. In response to such interactions, the user interactive device invokes the weight processor to alter weights. The propagation of weight alterations through the document component store enriches the agent model, and thus enables the document component selector and the weighted presentation grid to make choices on behalf of the user.

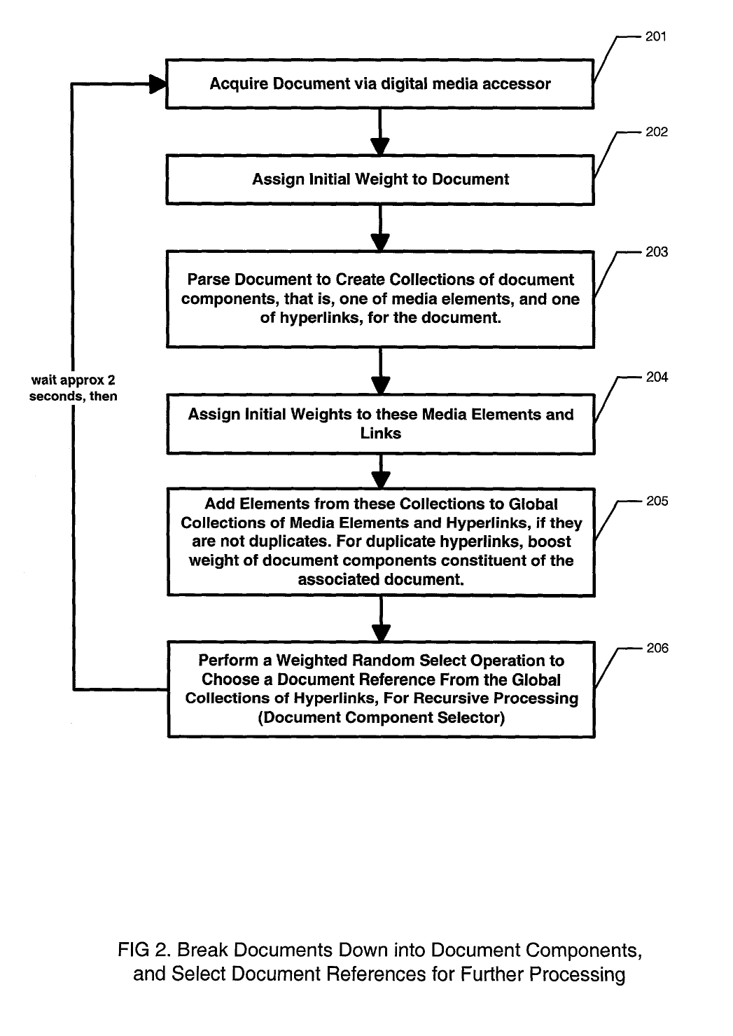

FIG. 2 is flow chart of the process of breaking documents down into document components, and selecting document references for further processing. Documents are acquired via the digital media accessor, block 201. At the start of a session, these documents come from a user-specified source or sources. In the broadest application of the invention, the user may select from a database or network source. In the currently preferred embodiment, media elements for display on the weighted presentation grid are acquired through the decomposition of acquired web pages. The starting point may include one or more static sites, such as news sources like CNN and The New York Times. The source of media elements may also include those sites having dynamic content. For example, the results of dynamic queries to commercial search engines like Yahoo and Excite may be used.

Once a document has been acquired, the weight processor assigns an initial weight to it, block 202. Then the document is parsed, block 203, to identify document components, and among the document components, create a collection of hyperlinks, and one of media elements, in order to represent the document. Weights are assigned to each document component, hyperlink, and media element, block 204. In the preferred embodiment of the invention, each media element is either a link to an image, or a chunk of text, i.e., a segment of text not longer than a paragraph. Certain HTML tags—specifically, the <BR>, <P>, <TR>, <UL>, and <DL> tags—always delimit the start of a text chunk. The document components are also added to the media elements and hyperlinks collections in the document component store, if they have not been encountered previously, block 205. In the case of hyperlinks which have been encountered previously, the associated document has its significance raised. If it already has been downloaded and processed, its constituent document components have their significance weights raised also. In the current preferred embodiment, this boost is by a factor of 1.2, each time a hyperlink referring to the same document is encountered.

The present invention is not limited to obtaining media elements from the Web or to obtaining the documents via HTTP. A similar front end could be written to decompose other types of documents, such as those generated by word processors or composed in multimedia markup languages such as the Synchronized Multimedia Integration Language (SMIL)or to pull media elements directly from a relational database. The source materials could be stored via any mechanism, such as file server, CD-ROM, DVD-ROM, etc., and obtained via any protocol, such as remote procedure call or remote method invocation. Also, other media types, such as video, VRML, and Flash, could be supported.

Each time the system is ready to process a new document, a weighted random select operation, block 206, chooses a document reference from the global collection of hyperlinks, and then removes it from that collection. After waiting for approximately 2 seconds, the process of breaking down documents is repeated, based on the chosen reference.

### Weighted Presentation Grid Overview

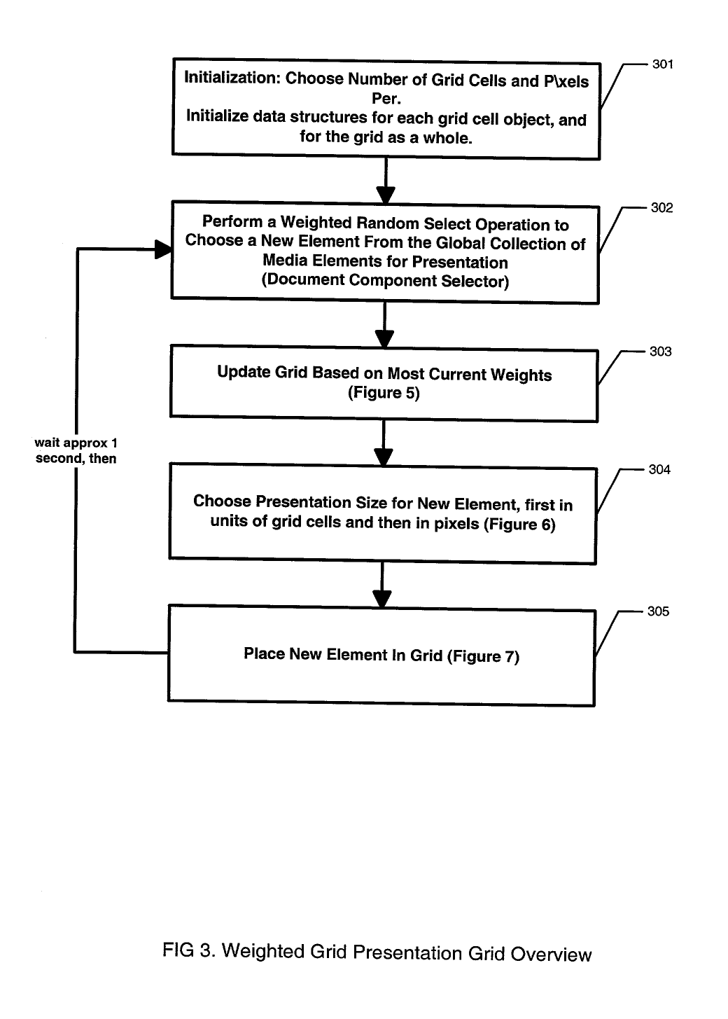

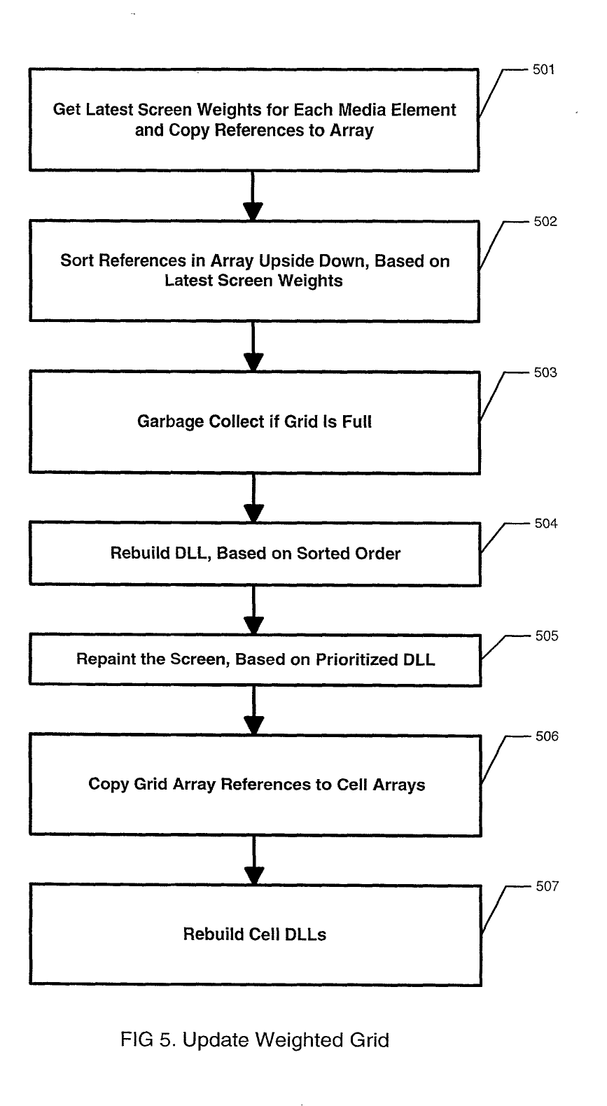

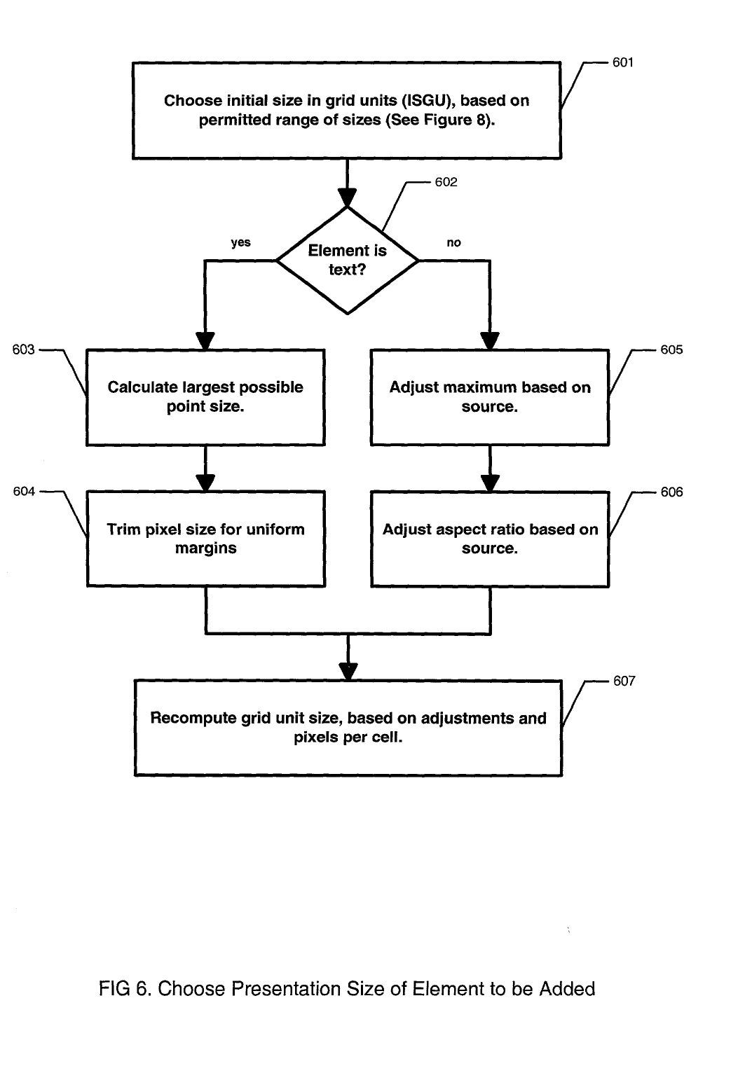

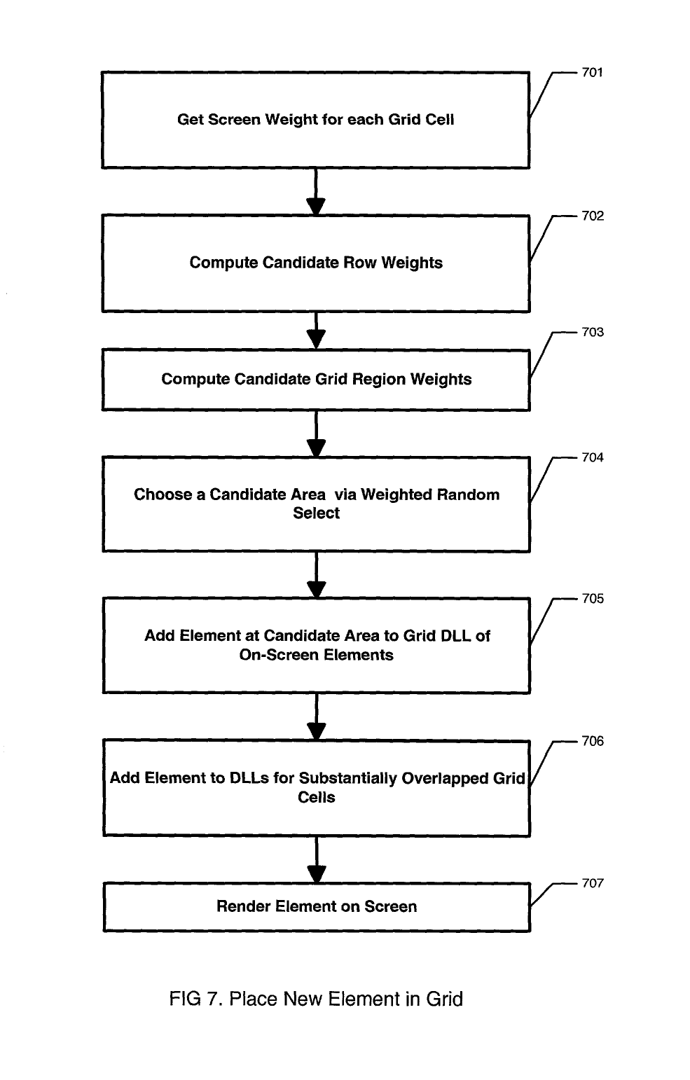

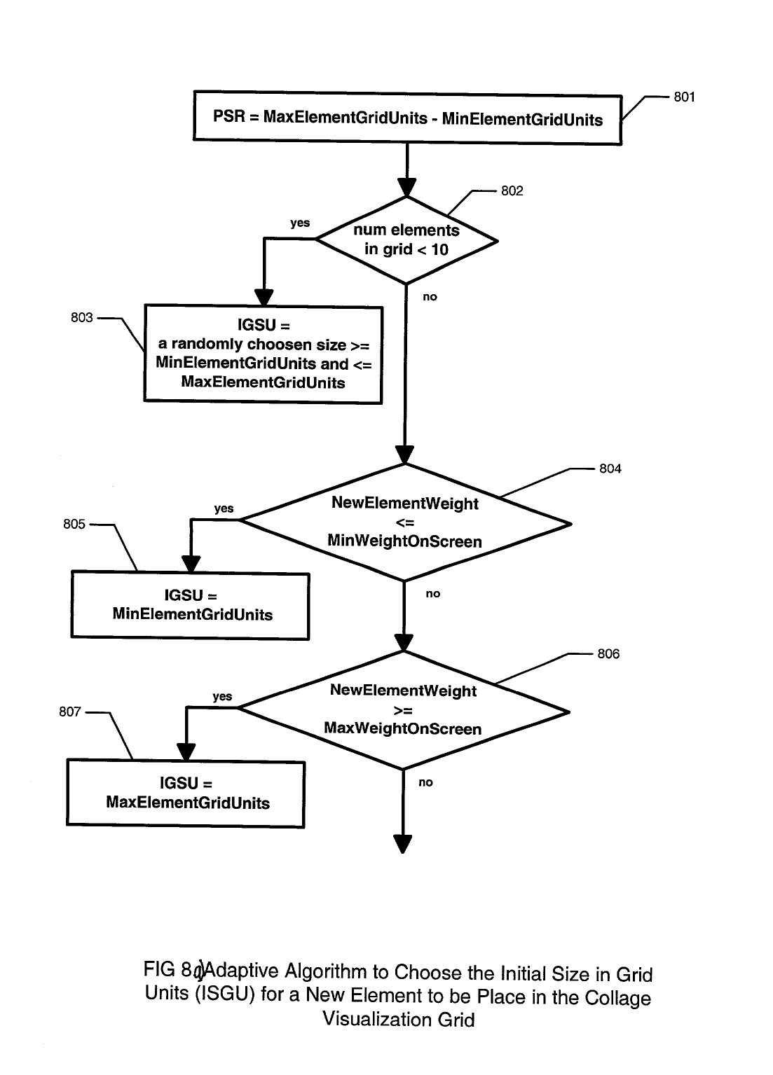

FIG. 3 shows an overview of the process of establishing a weighted presentation grid in the multimedia collage system. The weighted presentation grid optimizes the usage of screen real estate as the collage streams in, based on the agent model. During initialization, the screen area is broken down into a grid of cells, block 301. Each cell is not necessarily a square; its width and height are proportional to the total screen area the invention is using. The preferred embodiment of the invention uses a 12×12 or 24×24 grid. At a fixed time interval (for example, once per second), the document selector component provides a media element for display, which it chooses and removes from the global collection of available media elements, via weighted random select, block 302. Before displaying this new element, the grid updates itself, block 303, based on the latest weights set. This is described in greater detail below in relation to FIG. 5. A size is chosen for the element based on factors described later in this specification, block 304. This is described in greater detail below in relation to FIG. 6. The collage system decides where to place the element, block 305. This is described in greater detail below in relation to FIG. 7.

### Initialization

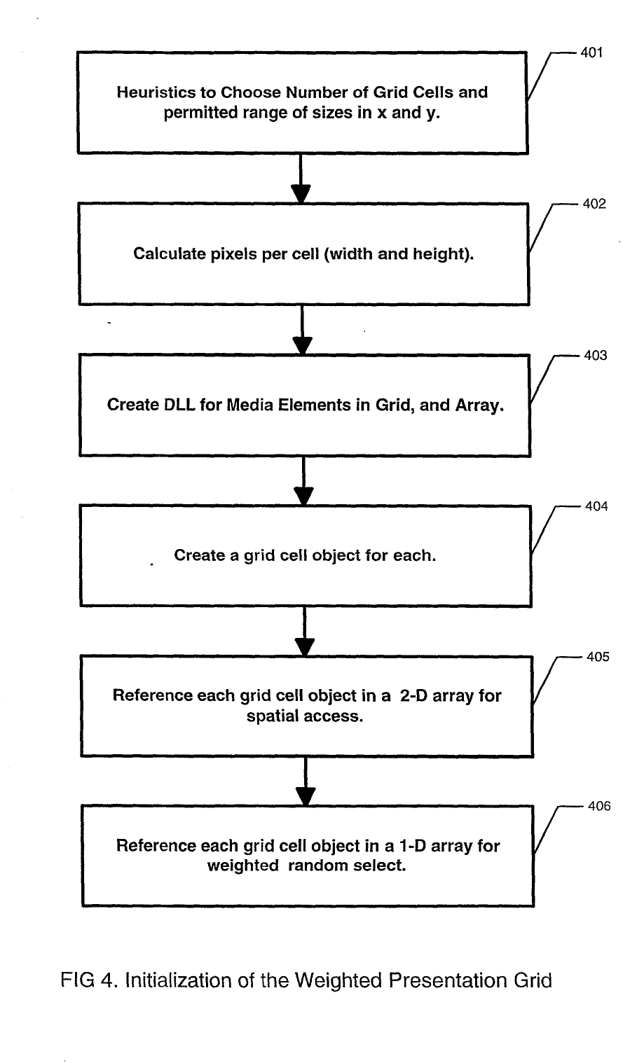

FIG. 4 shows the process of initializing the weighted presentation grid. The initialization stage begins with layout of the grid. Heuristics are executed to choose the number of grid cells, and the range of sizes, in cells, permitted for each element added to the collage, block 401. The minimum size of a displayed element, whether in grid units (MinElementGridUnits) or in pixels, should be big enough for a paragraph or image displayed to be visually intelligible. The minimum size, for example, may be a minimum width of 105 pixels, with height proportional to the aspect ratio of the display. An exact pixel width and height per cell is calculated, block 402. The maximum size of a displayed element is an aesthetic choice. The maximum size in the preferred embodiment of the invention is equal to one third of the width and height of the entire Visualization Grid.

The grid structure creates visual order for the user, and a means for optimizing utilization of screen real-estate. A doubly linked list (DLL) is created to keep track of all media elements which have been placed in the grid. The DLL is used to support fast insert and delete operations. Elements are stored in this list in the order corresponding to their stacking on the screen, that is, from bottom to top. An array to store media elements which have been placed in the grid is also allocated, to support fast sort operations, block 403. The size of the array is the maximum number of elements permitted within the grid. This maximum number is determined with regard to reasonable memory usage in order to allow only a reasonable depth of overlapping elements to be presented at one time. Next, a grid cell object is created for each cell, block 404. Each of these objects includes a doubly linked list to keep track of media elements which substantially overlap the cell. An array whose initial size is set in relation to the expected value of a maximum number of elements expected to overlap is allocated. If, however, the initial maximum number is exceeded, the array is resized. An array watermark index is set to 0. The array watermark index is used to keep track of how many references to media elements have been copied into the cell's array during the update operation, to be described below. Each cell object keeps track of its position in the grid, and includes slots for weighting calculations. Each of these grid cell objects is referenced from the grid both via a 2-D array for spatial access, block 405, and a 1-D array for weighted random select operations, block 406.

### Update Grid

FIG. 5 shows the process of updating the weighted presentation grid. The dynamic nature of the current invention is that the grid continuously updates its presentation of the media elements in order to reflect changes in the weights. The grid updates itself based on the most recent weights of the component elements each time a media element is received from the element source, before the element is actually added to the grid. First, the system loops through the grid's DLL of on-screen media elements, block 501. The weight processor determines the latest screen weight for each media element and assigns that weight to each element, except for a predetermined number of recent elements. In the preferred embodiment of the invention, the number of recent elements is fifteen. The number of elements can be dynamically decided on a per session basis based on grid size. The recent elements are assigned an especially low weight to make sure they are not covered up too quickly. This assignment process caches the weight with the element. This is done because the user needs some time to peruse the latest items. Also during this loop, the system copies references to each element into the array representation of the grid, in order. This updates the array to the current ordering of the DLL, and ensures that the array and the DLL contain references to the same elements.

Next, the system sorts the references to the media elements in the array based on the screen weights just obtained, block 502. A fast sorting algorithm is used, for example, Quicksort. The system does the sort upside down, so that the item with the highest weight is first.

If the grid contains the maximum number of elements permitted, the system deletes the element with the highest weight, block 503. Next, the system loops through all elements of the array to rebuild the DLL in the sorted order, block 504. The system repaints the screen based on the DLL, block 505. The elements on screen are now stacked in the inverse order of screen weight, so elements considered most important are on top and less important ones are underneath. If weights are changing, the effect the user sees is a sort of percolation of elements rising and falling.

While updating the grid, the structures for each individual cell must also be updated. A DLL is maintained for each cell, indicating which elements substantially overlap that cell, in the order of visible stacking. Similarly to the grid as a whole, an array is maintained in each cell for this update process. To update each cell, the system iterates through the grid's array again. For each element, the system calculates which cells are substantially overlapped. The element reference is copied into each of those cell's arrays, incrementing the watermark index, block 506. When this loop completes, the system executes an additional loop, over all the cell objects. The system iterates through each cell's array to rebuild its screen stacking ordered DLL, block 507. When the DLL for the cell is rebuilt, the system also resets the watermark index for next time.

### Choose Presentation Size

FIG. 6 shows the process of choosing a presentation size for each new element to be placed in the weighted presentation grid. To choose a presentation size for a new element to be placed, the system begins by assigning an initial size in grid units (ISGU) to the new element.

Using the pixels per cell, from block 601, the system calculates an initial size in pixels from the ISGU. Now, various pixel based adjustments may be required. The system determines whether or not the element is a text element, block 602. If the element is text, the system chooses a font face. The font face may be chosen by any aesthetic criteria, including font tags in the source document. The system determines the largest possible point size which can fit the text in the initial pixel size area, block 603, and trims the pixel size of element as needed to create uniform margins, block 604.

If the element is a bitmapped image (or a video or interactive multimedia), the size will have to be adjusted based on the source's pixel dimensions. First, neither dimension should be larger than that of the original—this may require scaling down, block 605. Second, the presentation size will need to be corrected to maintain aspect ratio, block 606. In the present embodiment of the invention, accepting the proposed width and scaling the height accordingly does this. In alternative embodiments of the invention, the opposite could be done, or heuristics could be applied to attain a compromise between the proposed and required widths and heights.

After pixel-based adjustments, the size of the element in grid units must be recomputed, again, using pixels per cell, block 607. Both sizes are stored with the object representing the element on-screen.

### Place New Element in Grid

FIG. 7 shows the process of placing a new element into the weighted presentation grid of the present invention. The system needs to determine where to place the new element in the grid, on the screen. The selected grid region should be one currently covered by unimportant elements, according to the agent model. The basic approach is to calculate grid region candidate weights for all possible grid cell origins where the new element can be placed. These calculations are based on size of element to be added (in grid cells) and the screen weight of each cell. If the element has width and or height greater than one grid cell, some rows and columns at the bottom and right borders of the display may not work as candidates, because placement there would mean a substantial part of the element would extend off the edge of the grid and screen. As part of the grid update, current screen weights are obtained and saved for each element in the grid. The DLL for each grid cell is updated so that the last element in the DLL refers to the topmost on-screen media element in the cell. So the weight for each cell, which is fed into the region area calculations, block 701, is simply the cached weight for the last element in the DLL. If the DLL is empty, the system uses a very large value to create a high likelihood that the cell will be selected as part of the placement area.

Next, candidate grid region weights must be calculated. In general, the calculation of an area would mean summing of contributions for each cell. In this case, however, because the weights vary across a wide range (i.e., the range of positive floating point numbers), it is better to add the logarithms of the weights. Multiplying the weights is mathematically equivalent. Each approach may have advantages. The multiplication approach may be more efficient, as calculating logarithms is time consuming. Logarithms have the advantage of compressing dynamic range. That is, when logarithms are used, overflow and underflow errors—which can result from the combined influences of several extreme values—will be prevented in a wide range of cases. In the following description of the algorithm, multiplication and division of weight values is employed. Addition and subtraction of logarithms could be substituted, equivalently.

A few optimizations are employed to eliminate redundant calculations. First, the system calculates “row” weights for each row segment that can participate in a grid region, block 702. That is, the system cycles through the candidate rows, and moving from left to right, for each candidate cell, calculates the contribution to the region weight that will come from that row. This requires the system to multiply the weights for a strip of adjacent cells corresponding to the presentation width. If width is greater than 2 cells, doing the full set of these multiplications only for the left-most cell further optimizes this. Then, for the next cell to the right, the system divides the previous row weight by the contribution from the cell to the left no longer involved and multiplies by the new cell coming in from the right. This is done for each column.

The system next calculates full candidate region weights, block 703, by cycling through the columns. The system multiplies the row weights from block 702 which contribute to each region. That is, the system multiplies the weights for a strip of adjacent cells corresponding to the presentation height. If the height is greater than 2 cells, doing the full set of these multiplications only for the top-most cell further optimizes this. Then, for the next cell down, the system divides the previous region weight by the row weight contribution from the cell above no longer involved and multiplies by the new cell coming in from the bottom. This is done for each candidate row.

The system now has screen weights for each candidate region of grid cells. From this set, a grid region for presentation of the new element is chosen. Whatever media elements(s) that are currently displayed on this grid region will be (at least partially) covered up by placement of the new element. As screen weights are represented as the inverse of significance, larger weights indicate that a region is a better choice for the new element. In alternative embodiments of the invention, the maximum screen-weighted candidate region could be used instead. In the preferred embodiment of the invention, an aesthetic choice is made to use weighted random select instead, block 704. The result is that while usage sessions follow an agent model, occasionally elements considered important by the model are covered up. The inverse representation of the weights is for the weighted random select algorithm (see definition above), which uses a larger incremental sum, based on a larger value, to create a larger probability of selection for a weighted element.

Once a region is selected, the system adds the element to the end of the DLL of elements in the grid, block 705. Based on the new element's size—which was used in the above calculations, and also based on the element's origin, which was determined by the candidate region weights and the random select operation—the system knows which grid cells the element covers. The system also adds references to the element to the end of the DLL for each grid cell, block 706.

Now the system can also render the element on the screen, block 707.

### Assignment of Initial Media Element Weights

Initial weights must be assigned to each element source (that is, each Web page in the current embodiment). One way to do this is to start with a weight of 1. Then, as the page is further from the original source, it is assigned a lower significance weight. This means that pages and elements closer to the source will be weighted higher. The effect is to favor breadth-first, instead of depth-first searching. Each page keeps track of how many levels removed it is from the original source, adding one to its immediate source to get this number. For example, the weighting component maps these levels to significance weights is as follows: 1, 0.8, 0.64, 0.6, 0.5, 0.4, 0.33, 0.25, 0.2, 0.16, 0.125, 0.1. In alternative embodiments of the invention other mapping schemes may be used.

Media elements inherit the significance weight of the page from which they came. Additionally, media elements are weighted such that JPEG images are more significant, GIF images are of intermediate significance, and text elements are less significant.

### Choose Initial Size in Grid Units (ISGU) for a New Element

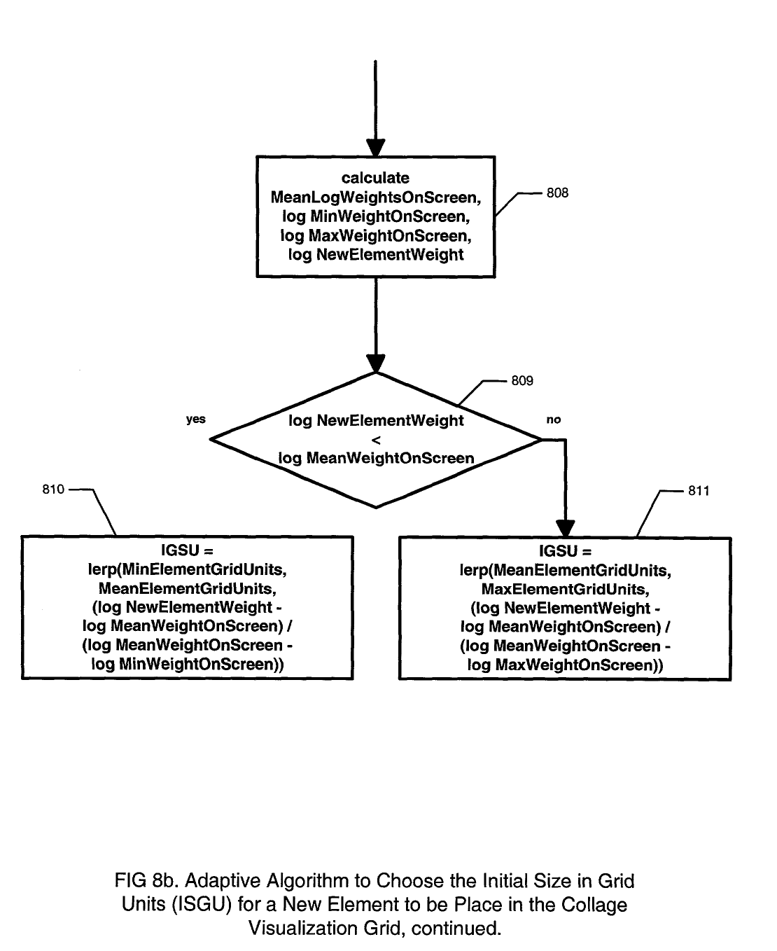

FIG. 8 shows the process of determining the initial size in grid units (ISGU) for new elements to be placed in the visualization grid. The ISGU is based on the range of permitted sizes in grid units chosen during initialization, block 801. This range of sizes is referred to as the Permitted Size Range (PSR). During the initial period of a session, while there are fewer than 10 elements in the collage visualization, block 802, the system randomly chooses a width and height within this range for the ISGU, block 803. After that, it uses the following adaptive algorithm to choose the new element's ISGU. If the weight of the new element (NewElementWeight) is less than or equal to that of the on screen element with the minimum significance weight (MinWeightOnScreen), block 804, IGSU is set to maximum number of grid units, block 805. If NewElementWeight is greater than or equal to that of the on screen element with the maximum significance weight (MaxWeightOnScreen), block 806, IGSU is set to maximum number of grid units, block 807. Otherwise the system calculates, block 808, the mean of the logarithms of the significance weights of the elements that are on screen, in the grid (the MeanLogWeightsOnScreen). The system also calculates the log of the minimum and maximum weighted element (logs MinWeightOnScreen and log MaxWeightOnScreen). The system compares the log of the significance weight for the new element to be placed (log NewElementWeight), to MeanLogWeightsOnScreen, block 809. If it is less than MeanLogWeightsOnScreen, the ISGU is the linear interpolation of the range between the minimum permitted size and the mean permitted size, based on the proportional extent to which the log NewElementWeight extends between the log MinWeightOnScreen, and the MeanLogWeightsOnScreen, block 810. Similarly, if log NewElementWeight is greater than or equal to MeanLogWeightsOnScreen, the ISGU is the linear interpolation of the range between the mean permitted size and the maximum permitted size, based on the proportional extent to which the log NewElementWeight extends between the MeanLogWeightsOnScreen, and log MaxWeightOnScreen, block 811.

### User Interactive Device Operations

The provided user interactive device is an interactive interface which permits the user to manipulate components in the presentation grid. The interactive interface provides the user with two tools. When the “I like” tool is activated, the user can lift elements and drag them with the mouse. As well as manipulating the visual presentation of the elements, the “I like” tool increases significance weights, both of the element in question, and of “related document components”. When the “I don't like” tool is activated, the user can remove elements through mouse clicks. The “I don't like” tool also decreases significance weights for related document components. These increases and decreases are referred to as weight alterations in the following paragraph.

Related document components are the primary associated document and its component parts. If the media element clicked on is a hyperlink, the primary associated document is the document referred to by the hyperlink. Otherwise, the primary associated document is the containing document which was the original source of the media element. All document components of the primary associated document are the related components whose weights are altered, along with that of the element. In the case of those document components which are hyperlinks that refer to documents which the system has already parsed, the weights of constituent document components are again altered. The recursion does not continue further. Other metrics of relatedness of document components could be reasonably applied in conjunction with this limited spreading activation.

### Agent Referential Structure

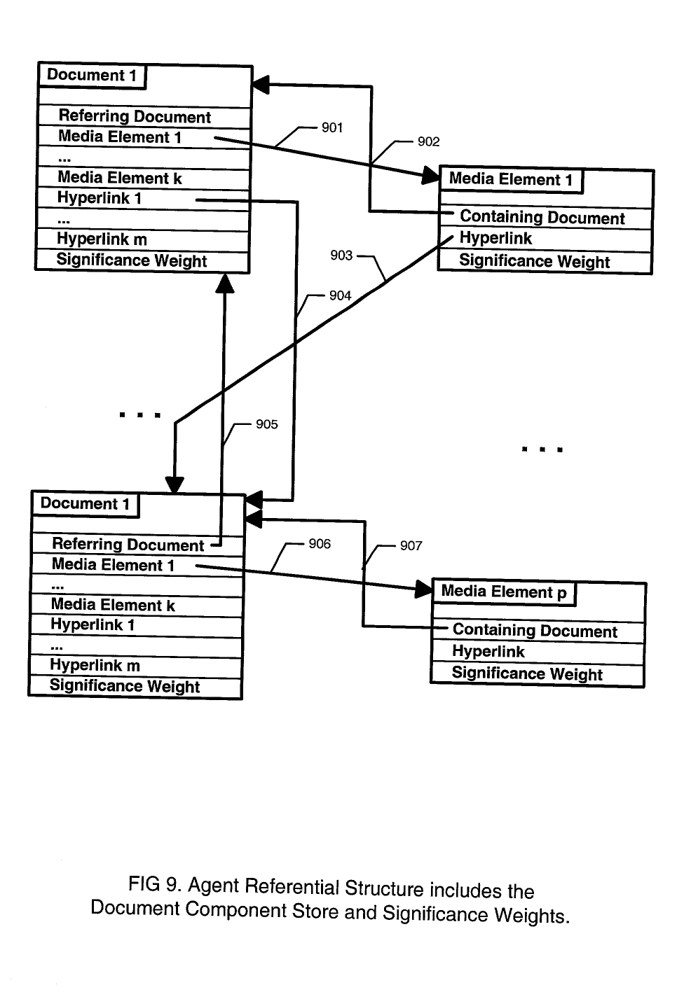

FIG. 9 shows an example of an agent referential structure of document components stored in the document component store. The Agent functionality in the invention does not reside in one software component. Rather, it is distributed across the application. A critical aspect of the agent is the Document Component Store's referential data structure, which keeps track of the relationships between document components. As described above, documents and media elements are nodes in a directed graph, whose connections (edges) represent the underlying hypermedia referential navigation structure. This data structure (FIG. 9 is an example) is built by the document parser 60, iteratively and recursively, over time, as the system retrieves documents. The significance weights are the quantified fields of the agent model, which represent the importance of documents and their components to users. The weight processor 70 sets and manipulates these significance weights, both establishing an initial weight and altering the significance weight over the course of operation of the invention.

FIG. 9 shows two of a set of n documents, and two of a set of p media elements (n and p are positive integers, each ellipsis within the figure refers to an indefinite number of additional entries). Generally, each document includes a reference to the first document parsed which refers to it, the Referring Document. Each document also contains references to k media elements and m other documents (through hyperlinks), where k and m are independent integers that may differ for each document. Conversely, each media element includes a reference back to its containing document, i.e., the first parsed document of which it was part. The media element may be embedded in a hyperlink (in the case of text, or of image maps, a link may also apply only to part of an element), in which case its hyperlink field will also refer back to some document structure. Such a document structure may not have been retrieved and parsed.

In the example of FIG. 9, Media Element 1 is part of Document 1 (edge 901), which means also that Document 1 is the containing document of Media Element 1 (edge 902). Media Element 1 is also hyperlinked to Document n (edge 903). This means that Document 1 includes a hyperlink to Document n (edge 904). Conversely, the referring document for Document n is Document 1 (edge 905). Document n includes Media Element p (edge 906), and thus Media Element p's containing document is Document n (edge 907). Media Element p is not part of any hyperlink. The primary associated document for Media Element 1 is Document n because it includes a hyperlink which refers to it. Because it includes no hyperlink, the primary associated document for Media Element p is its containing document, which is also Document n.

The appendix has an exemplary screen shot of the present invention. It shows a plurality of overlapping document components on a display.

These document and media element objects are the primary place where significance weights are stored. That is, each document and media element includes a significance weight field. These fields are initially set by the weight processor during parsing. The weight of the referring document is factored into the weight of a new document just before it is parsed. Similarly, media elements initially inherit significance weights from their containing documents. These media element weight fields are altered in response to interactions with the weight processor. The weight processor uses the document store referential structure in order to propagate weights to the media element's primary associated document, which is either the hyperlinked document, if there is one; or if not, the containing document. As described above (weight alteration component), weight alterations are recursively propagated through one level of a spreading activation network to the constituent document components of the primary associated document. The agent is embodied by this initialization of weights, and the propagation of their alteration through the depicted nodes of the Document Store's referential structure.

A weighted presentation system for media elements is beneficial because it enables representative portions of many documents to be displayed at one time. It is crucial to allocate screen real estate in such a system based on an agent model which represents the user's interests, so the screen is best used to show the media elements that matter to the user.

Thus, it would be desirable to calculate, based on the size of a new media element to be placed, the weight associated with every possible location on the screen where the element could be placed. Each possible location is called a candidate region.

The high resolution of modern bitmap graphical displays means that calculations that consider the weight associated with every point on the screen (that is, every upper left hand corner where it would fit), would require performing this computation for approximately one million possible candidate regions. As the new elements are placed in the collage approximately once per second, and these placement operations are not the only operations the system must perform, and each calculation is, in itself, time consuming, therefore this is not practical. Instead, a placement grid of 12×12 or 24×24 units is imposed. Candidate regions can only start on the placement grid. Thus, the total number of candidate regions is on the order of 100-500, a much smaller number that can be performed on a modern computer in a reasonable amount of time.

It is to be understood that the above-described embodiments are simply illustrative of the principles of the invention. Various and other modifications and changes may be made by those skilled in the art which will embody the principles of the invention and fall within the spirit and scope thereof.

What is claimed is:

1. A system for visualizing digital media, comprising:
a presentation grid for displaying selected document components, each component representing a document;
an accessor to acquire documents from at least one source of documents;
a document parser to parse said acquired documents and to divide said acquired document into document components; and
an agent to store said document components and relationships between said document components forming a model of user preferences, and said agent to select document components to display on said presentation grid according to said model.

2. The system of claim 1 wherein said agent alters said model in response to user input.

3. The system of claim 2 wherein said agent further comprises:
a document component store for storing said document components and said relationships according to said model.

4. The system of claim 3 wherein said agent further comprises:
a weight processor to assign initial weights to each document component generated by the document parser, and alter the weights of said document components, in response to user input; and
a document component selector to select document components for display on said presentation grid, said document components selected according to said model.

5. The system of claim 4 wherein said at least one weight comprises a significance weight indicating the significance of said document component in said model.

6. The system of claim 5 wherein said at least one weight further comprises a screen weight to be used in determining placement of said related document component in said presentation grid.

7. The system of claim 4 wherein said at least one weight is a floating point number.

8. The system of claim 1 wherein said accessor acquires HTML pages.

9. The system of claim 1 wherein said accessor acquires multimedia documents.

10. The system of claim 1 wherein said source is the Internet.

11. The system of claim 6 wherein said presentation grid further comprises a doubly linked list for fast insertion and deletion operations in an order corresponding to the stacking of said selected document components in said presentation grid to store said selected document components on display in said presentation grid.

12. The system of claim 6 wherein said presentation grid further comprises an array for storing said selected document components on display in said presentation grid, said array for rapid sorting of the document components in said presentation grid.

13. The system of claim 6 wherein said presentation grid further comprises a placement grid, said placement grid defining candidate regions for document component placement on said presentation grid, whereby calculations needed for document component placement are reduced.

14. The system of claim 13 wherein said placement grid further comprises a two dimensional array of grid cell objects wherein document components are placed by aligning the document component upper left corner on a grid cell object boundary.

15. The system of claim 14 wherein a doubly linked list for fast inserts in response to interaction and an array for fast sorting are both maintained for each grid cell object.

16. A method for adaptively computing the size of a new element to be placed in a weighted presentation grid, said method comprising the steps of:
a) deciding via heuristics the range of possible sizes for the new element, and computing the mean thereof;
b) comparing the logarithm of the significance weight of the new element;
c) if said logarithm is less than the mean of the significance weights of elements already in the presentation grid, setting the size to equal a linear interpolation of the position of said logarithm between the logarithm of the minimum of the significance weights of elements already in the presentation grid and the mean of the logarithms thereof, as applied to the range between the minimum and mean possible sizes for the new element; and
d) otherwise, setting the size to equal a linear interpolation of the position of said logarithm between the mean of the logarithms of the significance weights of elements already in the presentation grid and the logarithm of the maximum thereof, as applied to the range between the mean and maximum possible sizes for the new element.
